(19) United States
(12) Patent Application Publication
(10) Pub. No.: US 2014/0109179 A1
(43) Pub. Date: Apr. 17, 2014

(54) MULTIPLE SERVER ACCESS MANAGEMENT

(71) Applicants: Robert E. Walsh, Foster City, CA (US); Varun Goel, Diamond Bar, CA (US)

(72) Inventors: Robert E. Walsh, Foster City, CA (US); Varun Goel, Diamond Bar, CA (US)

(21) Appl. No.: 14/074,654

(22) Filed: Nov. 7, 2013

Related U.S. Application Data
(63) Continuation of application No. 13/085,127, filed on Apr. 12, 2011, now abandoned.
(60) Provisional application No. 61/323,077, filed on Apr. 12, 2010.

(51) Int. Cl. H04L 29/06

(52) U.S. Cl. CPC H04L 63/20
USPC 726/1

(57) ABSTRACT

An access management system receives an access request for a target computer from a client computer. The access request comprises a digital certificate belonging to a user. The access management system verifies the identity of the user by validating the digital certificate. When so verified, the user receives access privileges from a policy database. The access privileges contain one or more access attributes. The access management system evaluates the access request based the one or more access attributes and grants the user access to the target computer if all the one or more access attributes are satisfied.

### CROSS-REFERENCE TO RELATED APPLICATION

This application claims priority from U.S. Provisional Appl. No. 61/323,077, filed Apr. 12, 2010, all of which is incorporated herein by reference in its entirety for all purposes.

### FIELD

The present invention relates to access management systems, and more particularly to tracking and logging access interactions with servers, and most particularly to public key authentication mechanisms with a centralized policy database for server resource access management.

### BACKGROUND

The Secure Shell (SSH) protocol allows client computers to connect with servers to perform services such as remote login, file transfer, file copy and other secure network services over an insecure network such as the Internet. With an SSH connection, passwords are encrypted so that account and group authentication credentials are protected. FIG. 1A is a block diagram of a portion of the Open Systems Interconnection (OSI) model established by the International standards organization (ISO) depicting layers involved in a conventional SSH establishment process. The SSH protocol 10 is employed to establish a secure remote login between a client 30 and a server 70. The client 30 includes a computer platform 12 having a transmission control protocol/Internet protocol (“TCP/IP”) connection 14, or other comparable data stream connection. Correspondingly, the server 70 includes a computer platform 52 having a TCP/IP connection 54.

In general, the SSH protocol 10 securely connects client 30 and server 70 by establishing a session key between transport layers 16 and 56 of the client and server, respectively. The transport layer protocol provides server authentication, confidentiality, and integrity.

Once the session key is established, a user authentication protocol authenticates the client user authentication layer 18 to the server user authentication layer 58. An encrypted tunnel is then multiplexed between the client connection layer 20 and the server connection layer 60.

Two common user authentication methods are password authentication and public key authentication (i.e.; asymmetric authentication). Password authentication involves using a password to access resources on a target computer. An account identifier and password are typically sent from the client computer over an unsecured network, such as the Internet, to the target computer. The target computer, having access to the password for the account identifier, compares the password it received from the client computer to the known password for that account identifier. If the password matches, access to the target computer is granted. Otherwise, access is denied.

Password authentication requires that the password itself be sent over the unsecured network to the target server. There is potential for the password to be compromised by being intercepted by an unauthorized recipient while in transit. If this happens, the unauthorized recipient can use the password to gain access to any resources that the account has permission to access. For this reason, a secured connection is necessary to protect the password while in transit.

In addition to being intercepted while in transit, there are a number of other ways in which a password can be comprised. Storing the password in an unsecured location, such a non-password protected computer or writing it down on a piece of paper, may give an unauthorized user access to the password. A password-protected computer may also be venerable to unauthorized users, or hackers, who can gain access to a password. Passwords are also susceptible to brute force attacks, which involves using all possible passwords until the proper password is found.

Password authentication is not particularly suited for all authentication scenarios. Frequently, a non-user account on a client computer requires access to a target computer. Whereas a user account is typically associated with an individual, a non-user account is typically associated with a software application or system. A non-user account may be a script or software application that communicates with other software applications. For example, consider a software application that creates daily sales reports for an online store. The software application may run on a dedicated computer (i.e.; a client) and access the database (i.e.; a target) using its own non-user account in order to extract daily sales data. Authentication occurs each time the software application access the database. Since this occurs automatically and without human interaction, the password must be accessible to the software application. Having a password either accessible to the software application or coded into the software application itself increases the risk that the password will be compromised.

In addition, once a password is compromised, an unauthorized user can use the password until the password is changed. To minimize the risk of unauthorized access, passwords are typically only valid for a set time period. Therefore, maintaining security when using password authentication requires periodically changing passwords. This is not compatible with a non-user account in the above example because it would necessitate routinely modifying each no-user account every time the password is changed. If the account is not updated timely, the non-user account will be denied access, potentially leading to down time and interruptions in proper software operation.

Public key authentication is more sophisticated and secure than password authentication. Public key authentication uses a pair of keys, a public and a private key, that are generated by an algorithm. The keys are mathematically linked so they complement each other: one key can lock (i.e.; encrypt) data while the other can unlock (i.e.; decrypt) data encrypted by the other key. In one implementation of public key authentication, authentication occurs by encrypting a message (i.e.; data) with the private key, also known as “digitally signing” the message, and sending the message to the target computer. The target computer attempts to decrypt the encrypted message using the public key. If the decryption attempt is successful, and the decrypted message contains appropriate information, access is granted to the target computer. Otherwise, access is denied.

Unlike password authentication, public key authentication can be used over an unsecured communication channel. A new digitally signed message is created for each authentication attempt. If a digitally signed message is intercepted by an unauthorized recipient, it can not be used for subsequent access to the target computer. In addition, because public key authentication is difficult to compromise, it can be used indefinitely and unlike password authentication, does not require periodic password changes to maintain high security. This makes public key authentication particularity well suited for non-user accounts.

The SSH protocol is described by various Internet drafts from the Internet Engineering Task Force (IETF) including “SSH Protocol Architecture,” “SSH Transport Layer Protocol,” “SSH Authentication Protocol,” and “SSH Connection Protocol.” Relevant documentation includes Ylonen, T. and C. Lonvick, Ed., “The Secure Shell (SSH) Protocol Architecture”, RFC 4251, January 2006, and Ylonen, T. and C. Lonvick, Ed., “The Secure Shell (SSH) Transport Layer Protocol”, RFC 4253, January 2006, Ylonen, T. and C. Lonvick, Ed., “The Secure Shell (SSH) Authentication Protocol”, RFC 4252, January 2006, and Ylonen, T. and C. Lonvick, Ed., “The Secure Shell (SSH) Connection Protocol”, RFC 4254, January 2006, all of which are incorporated by reference herein. While the drafts of this documentation provide various standards for the SSH protocol, there is no definitive security policy established that sets forth procedures by which a server authorizes a request when the server is presented with the request by a client computer to establish an authenticated and protected tunnel over which to run an SSH service. This has resulted in substantial management obstacles for enterprises that require employees, consultants and/or vendors to access network resources using an SSH connection. Conventionally, implementers must maintain, at each server, authorization policies for individual clients and accounts, i.e., users and applications.

In addition, SSH providers include various vendors and/or open source entities. The multiplicity of providers generally results in implementation of diverse authorization protocols. Authorization is generally distinct from authentication. Before authorization is used to determine whether an identified user has permission to access a given resource, user authentication is first used to reliably establish the identity of the user. One known authorization protocol allows a user, once authenticated, to use all resources available through the SSH connection. This clearly presents security problems in enterprises where different accounts are provided for access to specified network information.

One common approach to existing SSH security policy management and enforcement is the implementation of configuration files at each server using the SSH daemon, i.e., a server-centric approach. One attempt to enhance security policies with respect to an individual server operating in an SSH protocol is described in U.S. Pat. No. 6,851,113 issued to Hemsath and assigned to IBM, which is incorporated by reference herein. In the Hemsath patent, an extension is provided on an SSH server whereby a set of user credentials are created, and the credentials are associated with a session key. While Hemsath states that a policy database of allowed users and permissions is preferably maintained in a centralized location for ease of administration, this is referring only to a centralized user registry on the particular server. However, the Hemsath patent is not in any way concerned with problems that arise when several target servers operating in the SSH protocol are to be administered.

Another common approach to existing SSH security policy management and enforcement focuses on the interaction between user and non-user accounts. When logging into a client computer, a user is typically authenticated using password authentication. Once successfully logged in to the client computer, the user has access to applications on the client computer. The applications may be configured to connect to a target computer using public key authentication, but using the keys for the application, not the user.

For example, one application may allow users to generate sales reports based on data pulled from a database. An application that is permitted to access the database will have an account with the database. When a user, who successfully logged in to the client, runs the application on the client, the application authenticates with the database on the target computer using public key authentication. The application is authenticated using the public/private key pair belonging to the application's account. The database, therefore, has no access to the identify of the user running the application. Instead, the database only has access to the identity of the application requesting the data. A user accessing a resource in this manner (i.e. accessing a resource as an authenticated identity other than the one belonging to the user) is known as “impersonation.” In the above example, the user is impersonating the identity of the application in order to access data in the database.

A number of problems exist when using impersonation to provide security and control access. First, the private keys must be stored in an unsecured manner. That is, the private key must be accessible to the impersonator. This creates an opportunity to bypass security and access controls. Each application must have access to a private key in order to authenticate with the target resource, whether the resource is a computer or an application. A user who successfully gains access, whether authorized or unauthorized, to a computer where the application resides will also have access to the application's public/private key pair. If the user obtains the private key, then the user can bypass the security and access protections built into the application and then use the application's account and identity to directly access any resource accessible by that account. Access to data in this manner constitutes a security breach because there is no way to restrict, audit or track access in that the target computer has no knowledge of the identity of the user, and any access control imposed by the application has been bypassed.

Second, impersonation limits the ability to control access on a user-basis. When a user accesses an application on a target computer using impersonation, the application has no indication of the user's identity and therefore cannot control access based on the user's identity. Using impersonation, access is generally only controlled on an application-basis, not a user basis. With no ability to track or control access, it sometimes becomes necessary to segregate data across multiple computers, which increases hardware and maintenance costs.

Third, impersonation is sometimes used by system administrators because it is convenient. Impersonation gives the user specific rights that might be necessary for configuration, troubleshooting, or debugging. The practice, however, reduces overall system security because any activity while impersonating cannot be traced back to the actual user.

FIG. 1B is a flow diagram of an account authorization process on a server-centric level according to the prior art. The process starts 202 after the SSH session key has been established between the transport layers of the client computer and the server. This protects account information transmitted over the connection, including account names and passwords. The first decision step 204 queries the server as to whether the account is authenticated according to the existing authentication protocol of the SSH standards. If the account is not authenticated, then the establishment of the requested SSH tunnel is rejected at step 218.

If the account is authenticated, the process then proceeds to a series of steps to authorize the user based on a server-centric user registry or configuration file. A processing step 206 is invoked, in which the source, i.e., client computer, is identified. The next decision step 208 determines whether the account is allowed. In conventional SSH authorization protocols, this step generally assumes that the account is allowed to access the target server from any source computer unless a particular source is specified. If the decision at step 208 is affirmative, i.e., the account does not specify a particular source computer, then the SSH session is established 216.

If the decision at step 208 is negative, then the next decision step 210 determines whether the account access is permitted from the particular source based upon consultation with the server-centric user registry. If the decision at step 210 is affirmative, then the SSH session is established 216.

If the decision at step 210 is negative, the process flow proceeds to a primary group identification step 212, in which the primary group membership for the user is obtained. The primary group membership is used to determine at decision step 214 whether the identified group is allowed based on group permission retained in the user registry stored in the target server. If the decision 214 is affirmative, then the SSH session is established at step 216 without restriction based on the source identity. If the decision at step 214 is negative, establishment of the SSH session is rejected at step 218.

While a server-centric policy management system generally following the authorization process described with respect to FIG. 1B can be acceptable for systems with one server operating the SSH protocol, it has been found that relying upon individual server administration policies in organizations operating a plurality of servers is rather cumbersome. Many enterprises operate several thousand, or more, servers, with resources accessed from many thousands of client computers. Configuration files containing specific policies must be specified or replicated at each server, requiring updates on a regular basis and/or when accounts are changed. This is difficult, if not impossible, to implement on a real time basis, and hence the likelihood of error is increased.

By using server-centric security administration policies, each server itself is a so-called “weak link” that can be compromised. If a particular server having the configuration files is compromised, an intruder could not only access data at that server, but could also modify the configuration file and/or the user registry thereby facilitating future intrusions.

Active Directory is a directory service component to Windows® server platforms, and provides the means to manage the identities and relationships within and among Windows® servers. However, many servers employ operating systems other than the Windows® operating system, such as UNIX or Linux operating systems.

It would, therefore, be desirable to have an access management system for managing access by individual users to a plurality of servers that is independent of the operating system being run in each server, and that avoids the practice of impersonation. Further, it would be desirable to store the policies in a variety of repositories; such Active Directory, LDAP directory, database, etc.

### SUMMARY

Implementations use a private public key of a user to directly authenticate with a server to establish a Secure Shell (SSH) connection without the use of impersonation. When impersonation occurs, it can be: a) denied, b) allowed to proceed and audited in either case. In addition, the use of the user's public keys can be combined with a centralized policy database to allow direct user identification that is centrally validated and audited. In one implementation, the user generates a public/private key pair. The private key is sent to the target server while requesting a resource on a target server using SSH. The user's identity is extracted from the public key and validated. The user is authorized or denied to use the resource based on the policies retrieved from the policy database.

### BRIEF DESCRIPTION OF THE DRAWINGS

FIG. 1A is a block diagram of a portion of the OSI model depicting a prior art SSH protocol stack;

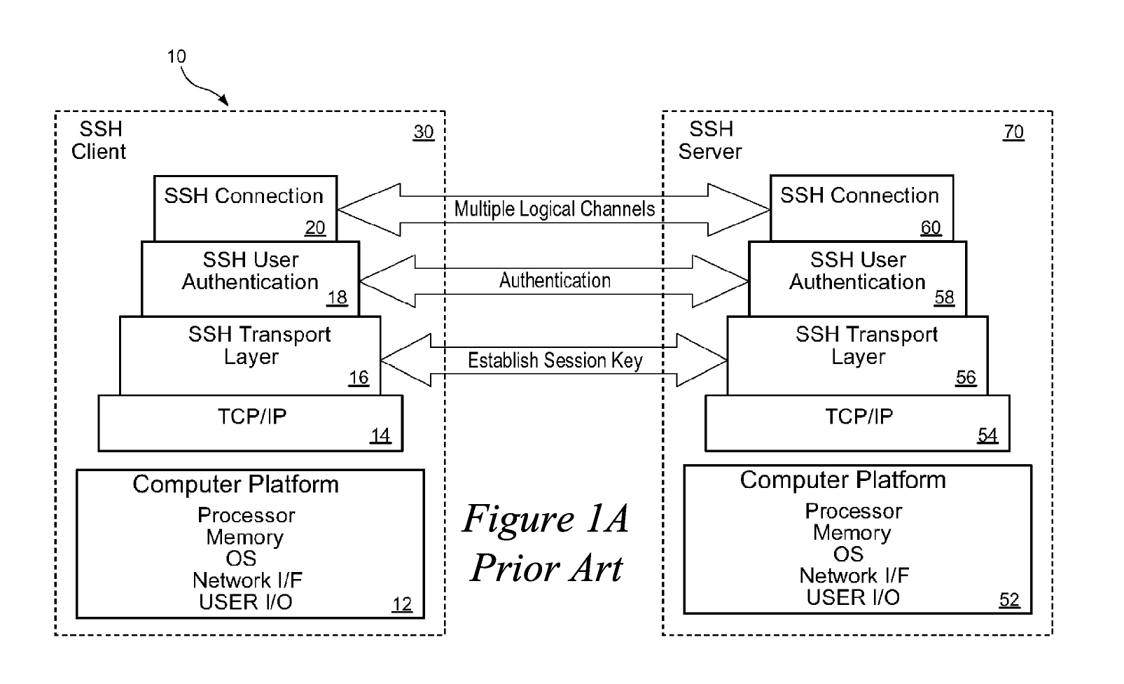

FIG. 1B is a prior art process flow diagram of account authentication of an account to a Secure Shell (SSH) server on a server-centric level;

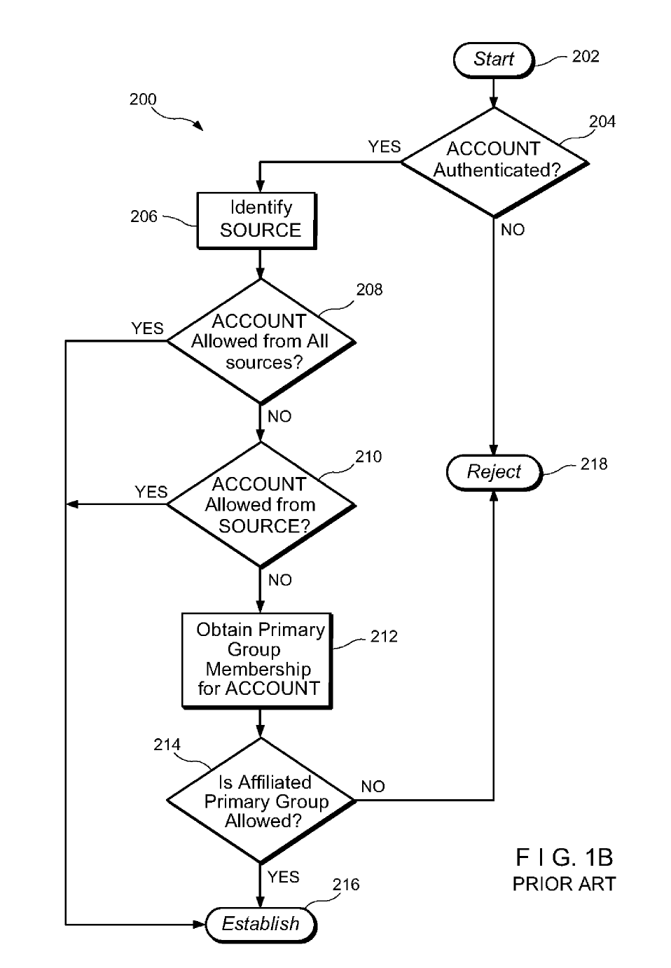

FIG. 2 is a schematic of an enterprise network operating the SSH protocol;

FIG. 3 is a block diagram of a system for managing SSH establishment;

FIG. 4 is a block diagram of a portion of the OSI model depicting an SSH protocol stack;

FIG. 5 is a block diagram of a SSH server computer;

FIG. 6 depicts exemplary tables with SSH authentication policies within a central access database;

FIG. 7 depicts an overview of a system for managing access to a plurality of SSH servers; and

FIG. 8 is a process flow diagram of SSH account authentication and authorization.

### DETAILED DESCRIPTION

Direct authentication with a server can be established by a Secure Shell (SSH) connection with a user's public key without an impersonation. A direct identification of the user can be centrally validated and tracked by using the user's public keys when combined with a centralized policy database. In one implementation, the private key of the user is used to generate a digital certificate, and a request is made using SSH for a resource on a target server. Using policies retrieved from the policy database, the user can be authorized to use the resource when the user's identity is validated. In another implementation, a client computer sends an access request to an access management system. The access request is for a target computer and includes a digital certificate belonging to a user. If the access management system can verify the identity of the user by validating the digital certificate, then the user can receive access privileges from a policy database. The access privileges from the policy database contain one or more access attributes. The one or more access attributes can be used by the access management system to evaluate the access request. Upon a successful evaluation, where each of the access attributes is satisfied, the access management system can grant the user access to the target computer.

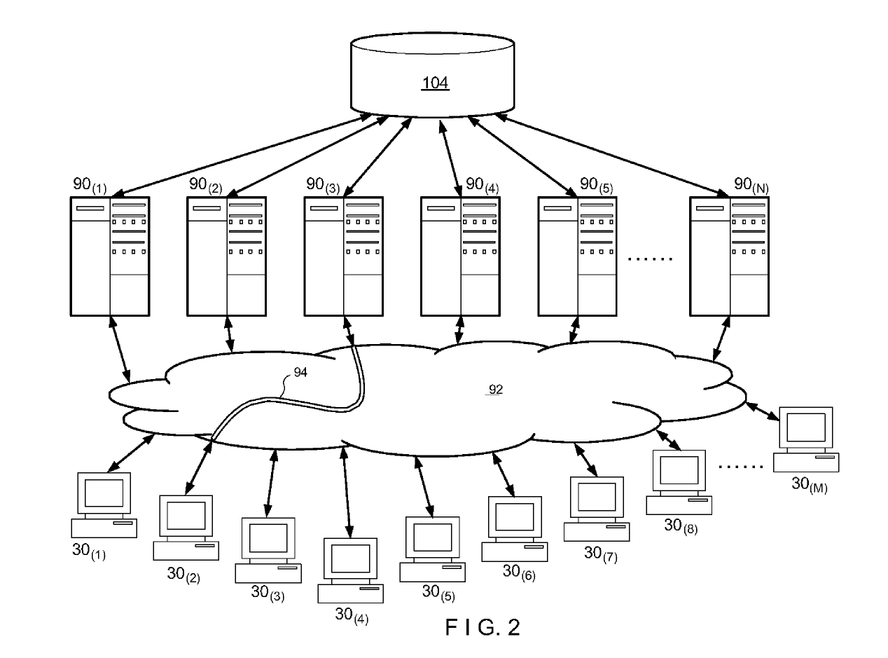

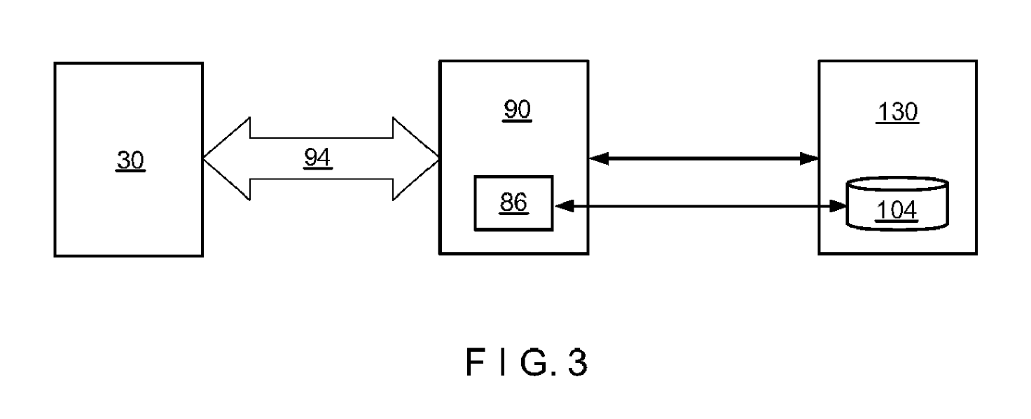

Referring to FIGS. 2 and 3, an SSH session request by an account from a particular source computer to access certain resources on a given target server is accomplished by consulting a policy database 104 that includes a set of attributes for each allowed account. The policy database 104 generally resides in memory of an attribute management computer 130, and is linked with a plurality of target SSH servers 90, denoted 90(1), 90(2), 90(3), 90(4), 90(5) . . . 90(N). The attribute management computer 130 stores and provides access to the policy database 104 for creation, modification, and management.

Target SSH servers 90(1−N) are connected to a common network 92, which can be an unsecured network such as the Internet or another wide area network, or a secured or unsecured network such as one or more intranets, extranets, local area networks, campus area networks, metropolitan area networks, or other local area network. A plurality of SSH enabled client computers 30, denoted 30(1), 30(2), 30(3), 30(4), 30(5), 30(6), 30(7), 30(8) . . . 30(M), are also connected to the network 92. The various servers and client computers operate in the SSH protocol independent of the operating system, and can include a heterogeneous network with servers based on various operating systems such as UNIX®, Linux, Windows NT or the like, and client computers based on Windows, UNIX, MAC OS, Linux or the like. An authenticated protected tunnel 94 is provided for the operation system-independent SSH connection protocol between one of the client computers 30 and one of the target servers 90 based on account attributes maintained in the policy database 104.

In particular, an access control module 86 is provided at each target server 90. In the implementation shown, the access control module 86 is part of the generally available SSH code which has been modified to retrieve the access rules from a central location, rather than from within the server. As such, the access control module 86 is executable to retrieve access rules in the policy database 104 to determine whether an account, requesting establishment of an SSH session to access certain resources on a target server with an SSH service from a particular client computer 30, has the requisite permissions with respect to the target server 90.

In another implementation, each target server 90(n) maintains a separate instance of the policy database 104, as opposed to being centrally maintained. The policy database 104 on each target server 90(n) must be periodically synchronized to maintain the proper user authentication settings.

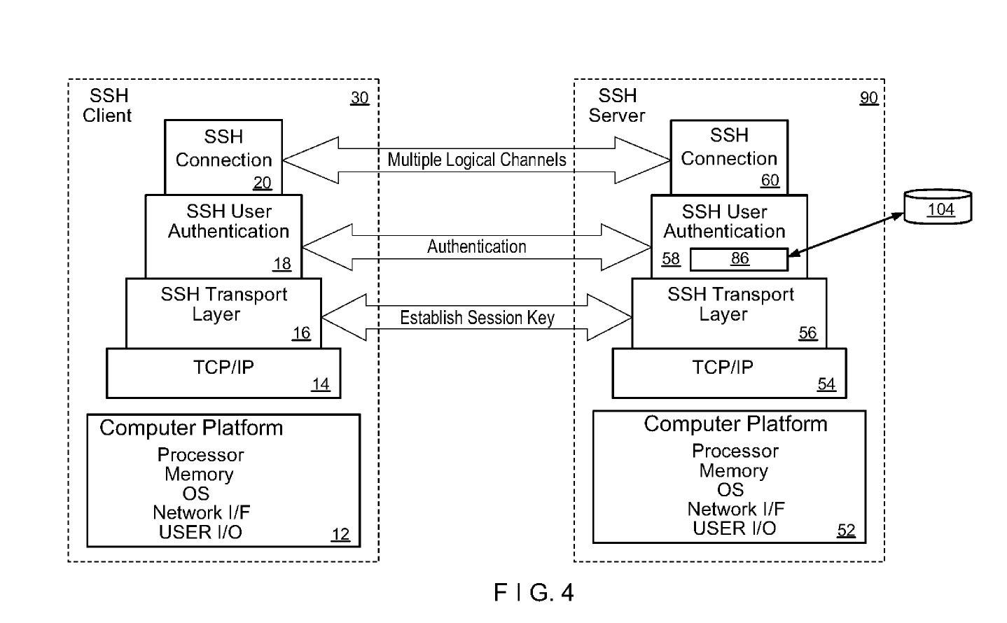

FIG. 4 depicts establishment of an SSH connection. The transport layer protocol operates in a typical manner in which a session key is invoked between transport layers 16 and 56 of the client computer 30 and the server 90, respectively, and the host computer is authenticated. Further details regarding the transport layer communications can be found in RFC 4251 and RFC 4253, which were incorporated by reference as stated elsewhere herein. After the server machine and host computer is authenticated an encrypted communications channel is established at the transport layer, user authentication occurs at the authentication layers 18 and 58 with a general implementation of the authentication protocol as is described in RFC 4252, which was incorporated by reference as stated elsewhere herein.

According to one implementation, user authentication occurs using public key authentication at the authentication layers 18 and 58. The private key associated with the logged-in user on client computer 30 is used to authenticate with the authentication layer 58. In another implementation, the user on client computer 30 may be logged into a generic account (i.e.; an open account that allows access without a log in for other authentication). The logged-in user provides the user's private key to authentication layer 18. Authentication layer 18 then authentications the user with the authentication layer 58.

According to one implementation, account authorization occurs at the authentication layer 58 of the target server 90(n) operating the access control module 86 to authorize the account requesting establishment of an SSH session to access resources at the target server 90(n). The access control module 86 generally receives a request from an account at the client computer 30 to establish a protected tunnel 94 between the client computer 30 and the target server 90(n) to access certain resources at the target server 90(n) under the SSH protocol.

In one implementation, authentication is implemented by the access control module 86 consulting with an authorized key store (not shown). The authorized key store is located on the target server 90(n). In another implementation, the authorized key store is located on policy database 104. The authorized key store contains the public keys of accounts that have access privileges to resources on target server 90(n). The authorized key store is used at the authentication layers 18 and 58 for public key authentication.

In one implementation, authorization is implemented by the access control module 86 consulting the policy database 104 to obtain account attributes, including access rules and policies. These access rules and policies govern access permissions for an account, using an account identity, to one or more individual servers from certain client computers based on the source computer identity. If the access control module 86 determines that the account has acceptable credentials to establish the requested session 94 as described herein and is using an approved authentication protocol (e.g.; password, public key, and/or impersonation), the encrypted tunnel is then multiplexed, i.e.; multiple logical channels established, between the client connection layer 20 and the server connection layer 60. The connection protocol is described in further detail in RFC 4251 and RFC 4254, which were incorporated by reference as stated elsewhere herein.

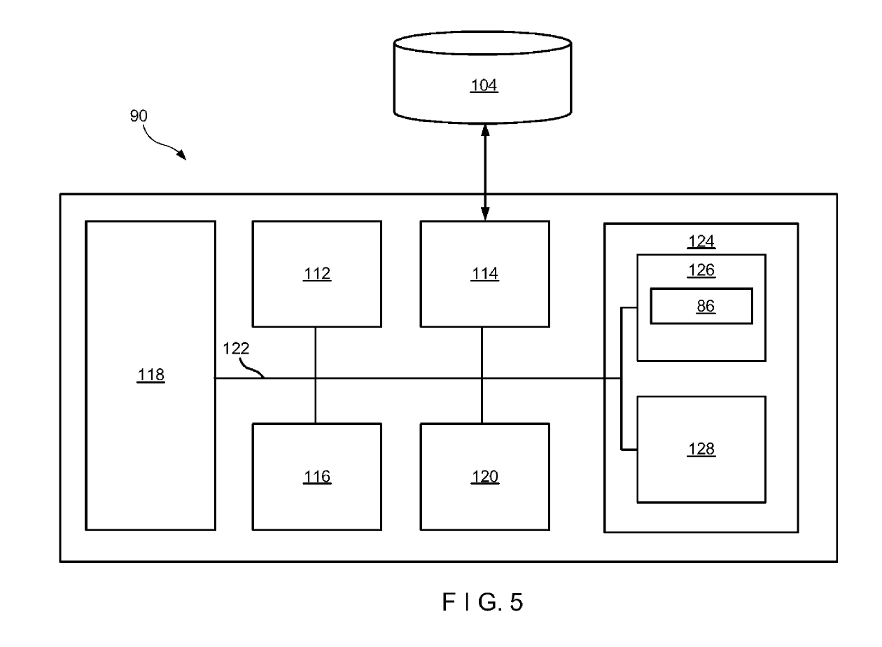

An exemplary server computer 90 in which the access control module 86 can be implemented is shown in FIG. 5. Server computer 90 includes a processor 112, such as a central processing unit, an input/output interlace 114, and support circuitry 116. In certain implementations, in which the server computer 90 requires a direct human interlace, a display 118 and an input device 120 such as a keyboard, mouse, or pointer are also provided. The display 118, input device 120, processor 112, input/output interlace 114, and support circuitry 116 are commonly connected to a bus 122, which is also connected to a memory 124. Memory 124 includes program storage memory 126 and data storage memory 128. Note that while server computer 90 is depicted with direct human interlace components display 118 and input device 120, programming of modules and display of data can alternatively be accomplished over the input/output interlace 114, for instance, in which the server computer 90 is connected to a network and the programming and display operations occur on a connected computer.

Program storage memory 126 and data storage memory 128 can each comprise volatile (RAM) and non-volatile (ROM) memory units and can also comprise hard disk and backup storage capacity. Both program storage memory 126 and data storage memory 128 can be embodied in a single memory device or separated in plural memory devices. Program storage memory 126 stores software program modules and associated data, and in particular stores the software code used for the SSH protocol stack including the transport layer protocol, the authentication layer protocol including the access control module 86, and the connection layer protocol.

The server computer 90 generally supports an operating system stored in program storage memory 126 and executed by the processor 112 from volatile memory. According to another implementation, the operating system or a separate program running under the operating system contains instructions for interlacing the device 90 to the policy database 104 over the input/output interlace 114, as more fully discussed herein. In addition, as discussed above, the SSH protocol is designed as compatible in a heterogeneous network, and accordingly the operating systems of the server computers 90(1), 90(2), 90(3), 90(4), 90(5) . . . 90(N) can be the same or different.

It is to be appreciated by one of ordinary skill in the art that the server computer 90 can be any computer such as a personal computer, minicomputer, workstation, mainframe, a dedicated controller such as a programmable logic controller, or a combination thereof. While the server computer 90 is shown, for illustration purposes, as a single computer unit, the server computer can comprise a group/farm of computers which can be scaled depending on the processing load and repository size. It will also be understood by one of ordinary skill in the art that client computer 30 and attribute management computer 130 can have the same or similar architecture as the server computer 90.

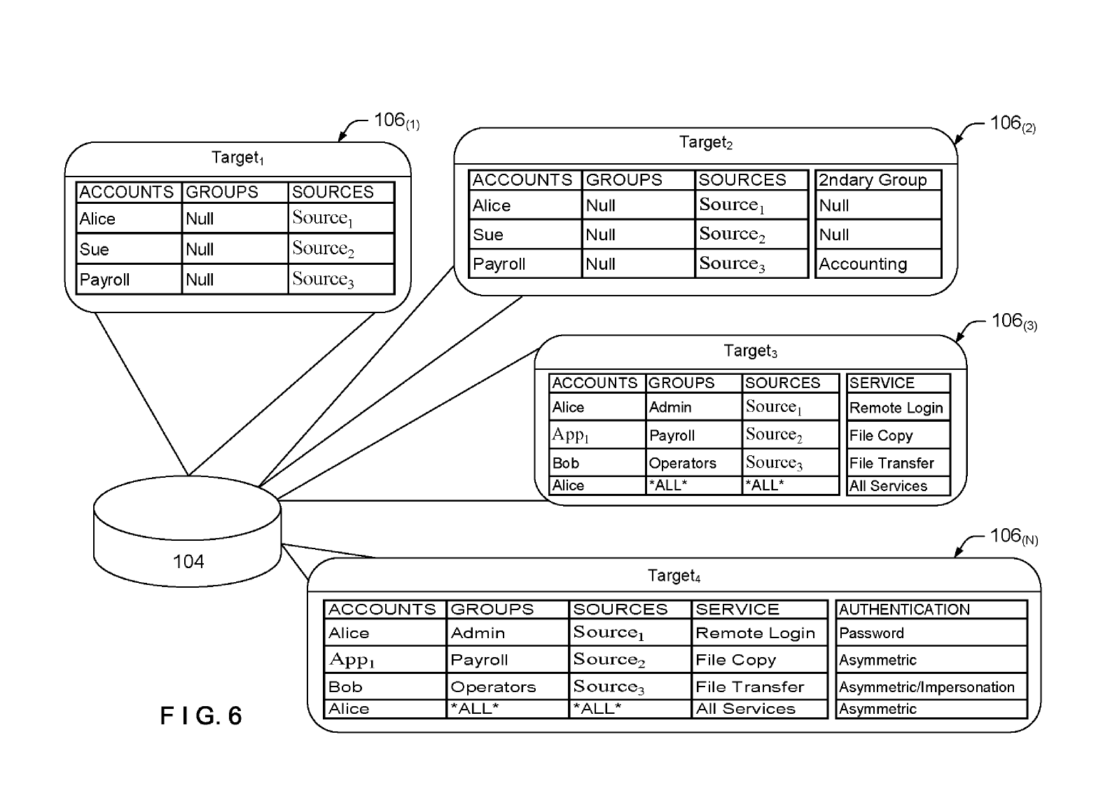

FIG. 6 depicts various implementations of sets of access rules in a policy database 104 for servers 90(1), 90(2) . . . 90(N), in the form of tables 106(1), 106(2), 106(3) . . . 106(N). While the policy database 104 is depicted in the form of tables, i.e., part of a relational database, various types of stores can be implemented to store policies, including but not limited to databases, spreadsheets, directories, flat files, and other types of repositories or data stores. The policy database 104 includes sets of access rules with attributes including an account identity; a client computer identity, i.e., source identity; group identities, including primary groups and one or more secondary groups; service identity; and combinations comprising account identity and client computer identity, and one or more of group identity and service identity. Table 106(1) shows attributes including account identity and client computer (i.e., source) identity. Table 106(2) also incorporates secondary groups, whereby a user can belong to multiple groups, and membership in any one of the groups that are specified in the table will allow access to the designated server. Table 106(3) specifies an additional attribute of the requested service, whereby an account attempting to establish an authenticated and protected tunnel over which to run an SSH service from a particular client computer is only granted permission for the designated service. The designated attribute for a particular account can be limited to one or more specific client computers and/or services, or can specify that a given account has permissions to access one or more target servers from all client computers and/or can request all SSH services. Table 106(N) also incorporates authentication type, whereby an account attempting to establish an authenticated and protected tunnel over which to run an SSH service from a particular client computer is only granted permission for a specific authentication type.

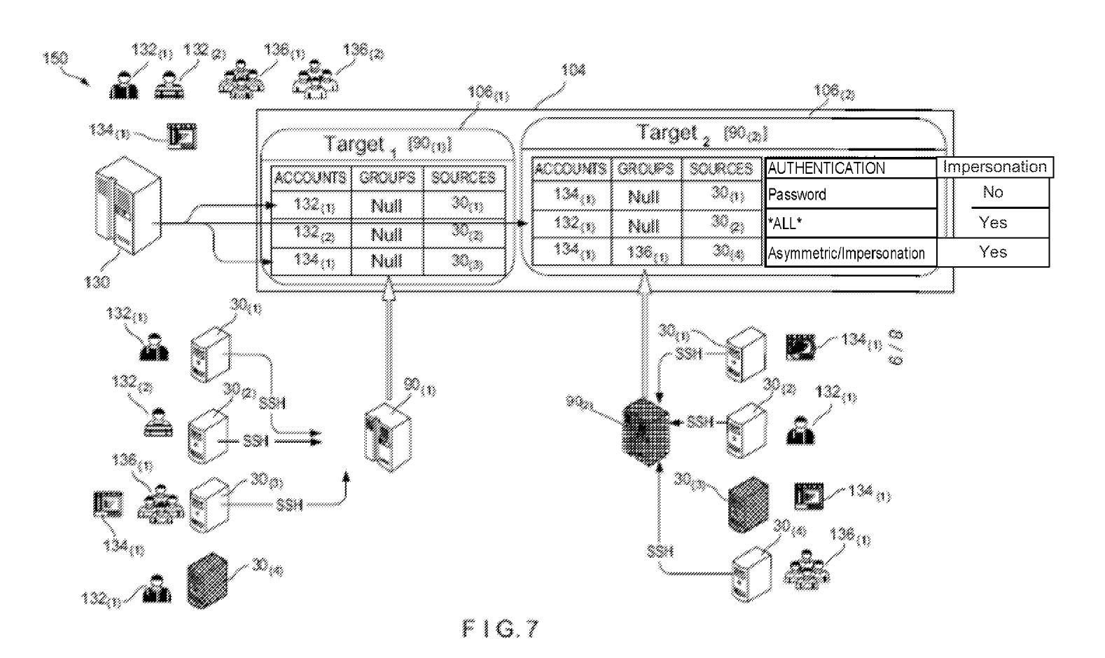

Referring now to FIG. 7, a depiction of a system 150 for managing access to a plurality of servers in an organization is provided. The system 150 includes the attribute management computer 130 including the policy database 104 having sets of attributes for a plurality of the target servers 90, e.g., as depicted, 90(1) and 90(2), in the form of tables 106(1) and 106(2). The tables contain attributes including identity of the accounts, which can be in the form of users 132(1), 132(2) . . . 132(A) and applications 134(1) . . . 134(B). In addition, the tables contain a group identity attribute for groups or secondary groups 136(1), 136(2) . . . 136(C). The tables further specify a source, i.e., client computer 30(1), 30(2), 30(3), 30(4), from which the account or group can access the specified target server 90(1) or 90(2). In the example depicted, when user 132(1) attempts to establish an authenticated and protected tunnel over which to run an SSH service with target server 90(1) from client computer 30(1), the target server 90(1), i.e.; the access control module 86 programmed therein, accesses or, in some implementations, downloads a portion of the table 106(1) of the policy database 104 which corresponds to the user attempting access. In one implementation, the access control module 86 authenticates the user using an authentication method, such as password authentication, public key authentication, or impersonation combined with either password or public key authentication. Then, the access control module 86 determines whether credentials exist to allow user 132(1) to establish an authenticated and protected tunnel with server 90(1) from client computer 30(1), based on the access rules.

In this example, since table 106(1), which provides credentials for server 90(1), lists user 132(1) in the same row as client computer 30(1), indicating positive credentials, hence an SSH connection will be established for the requested resources. Likewise, when user 132(2) attempts to establish an authenticated and protected tunnel over which to run an SSH service with target server 90(1) from client computer 30(2), the tunnel will be established because user 132(2) is listed in table 106(1) with positive credentials to access server 90(1) from client computer 30(2). In addition, an attempt to establish an authenticated and protected tunnel over which to run an SSH service with target server 90(1) from client computer 30(3) using the application 134(1) will be allowed, because the account for application 134(1) is listed in table 106(1) with positive credentials from client computer 30(3). Note that none of the depicted accounts, including user 132(1), user 132(2), and application 134(1) are listed as having access to server 90(1) from client computer 30(4) in table 106(1). Therefore, attempts by user 132(1), user 132(2), application 134(1), or the group 136(1) to establish an authenticated and protected tunnel over which to run an SSH service with server 90(1) from client computer 30(4) will be denied.

Likewise, referring to table 106(2) in FIG. 7, which provides access credential attributes for target server 90(2), an attempt to establish an authenticated and protected tunnel over which to run an SSH service with target server 90(2) from client computer 30(1) using the application 134(1) will be allowed for password authentication, because the account for application 134(1) is listed in table 106(2) with positive credentials from client computer 30(1). If application 134(1) attempts to authenticate using another authentication scheme, such as public key authentication or password authentication coupled with impersonation, authorization will fail and the attempt to establish an authenticated and protected tunnel will be denied. If 132(1) attempts to establish an SSH tunnel with target server 90(2) from client computer 30(2), the tunnel will be established because user 132(1) is listed in table 106(2) with positive credentials to access server 90(2) from client computer 30(2) using any authentication scheme. When a member of group 136(1) attempts to establish an SSH tunnel with target server 90(2) from client computer 30(4), using the application designated account 134(1) the tunnel will be allowed, but only for a public key/impersonation authentication scheme, because group 136(1) is listed in table 106(2) with positive credentials from client computer 30(4).

In one implementation, the public key/impersonation authentication scheme requires that a member of group 136(1) authenticate successfully with 30(4) using public key authentication but then access target server 90(2) under a different identify that has also been authenticated by public key authentication (i.e.; connect via impersonation).

If user 132(1), application 134(1), or a member of the group 136(1) attempts to establish an authenticated and protected tunnel over which to run an SSH service with target server 90(2) from client computer 30(3), the requested SSH session will be denied as none of those accounts 132(1), 132(2), or 134(1), or the groups 136(1) or 136(2), have the requisite credentials in table 106(2).

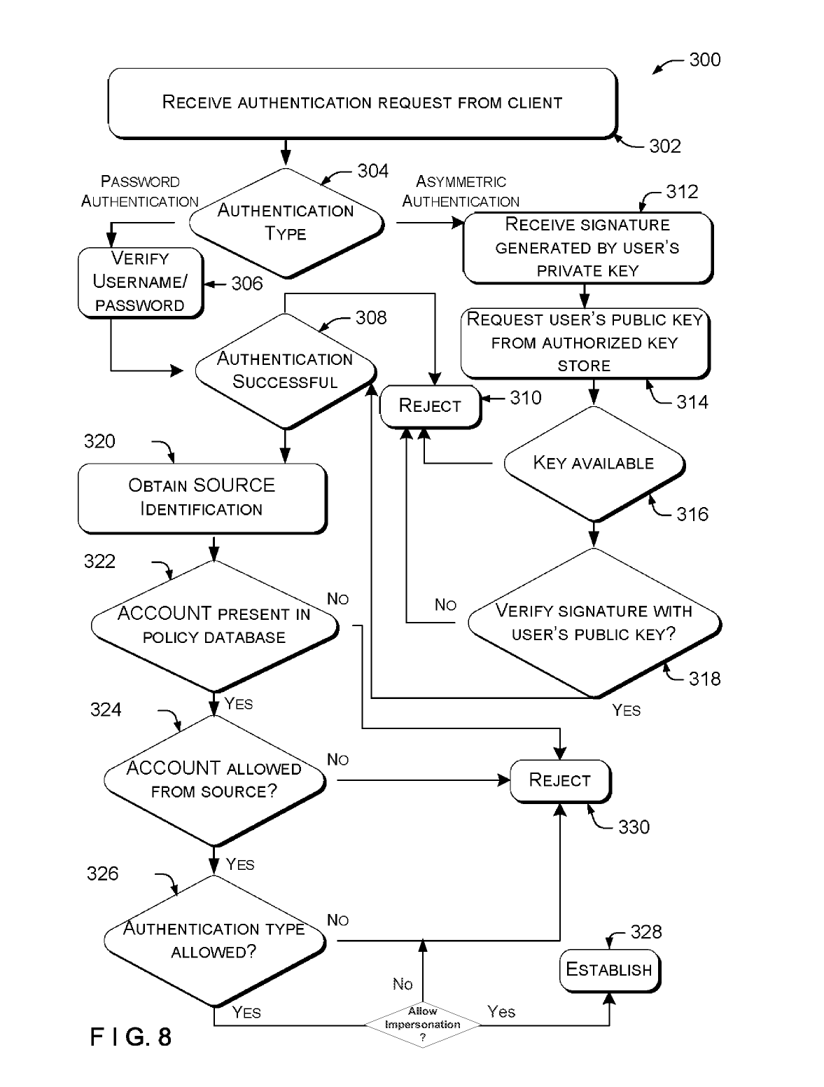

FIG. 8 is a decision flow diagram of an account authorization process 300 that is implemented at the target server 90 with which an SSH session request for a particular service has been received from a particular source computer 30. The process 300 is part of the access control module 86. After the SSH session key has been established between the transport layers of the client computer and the server, which protects account information transmitted over the connection, including account names, passwords, and digital certificates, an authentication request from the client is received by the target server in step 302. The type of authentication is determined at step 304.

If the authentication type determined at step 304 is password authentication, the username and password of the account is verified at step 306. The success of the authentication is evaluated at step 308. If authentication failed, the request to establish an SSH session is rejected 310.

If the authentication type determined at step 304 is public key authentication, a digital signature generated by the user's private key is received at step 312 along with other information, such as the user's account name. Next, the user's public key is requested from the authorized key store in step 314 based on the user's account name. If the public key does not exist for the specified account name at step 316, the request to establish an SSH session is rejected 310. In one implementation, the authorized key store is located in the policy database 104. In another implementation, the authorized key store is maintained at each server 90.

If the public key is available and successfully retrieved, the public key is used to decrypt and verify the digital signature at step 318. If decryption or verification fails in step 318, the request to establish an SSH session is rejected at step 310. In one implementation, the verification step includes inspecting the data fields contained in the decrypted digital signature, which may contain identification information for the user and account. If the necessary information is missing, incomplete, or is invalid, the request to establish an SSH session is rejected 310. The success of the authentication is evaluated at step 308. If authentication failed, the request to establish an SSH session is rejected at step 310. Further details regarding public key authentication can be found, for instance, in RFC 4252, which was incorporated by reference as stated elsewhere herein.

If the account is affirmatively authenticated at the authentication step 308, the account authorization process 300 continues with a source identification step 320, in which the source, i.e., client computer, identification information is obtained. This can be accomplished using the IP address of the source computer 30 directly, or, as depicted, for instance, in FIG. 6, using a more common computer name, i.e., using a name resolution or name lookup procedure. A directory of IP addresses and associated computer names can be maintained at each computer or in a policy database 104, which may be located at each server 90 or may be centrally located at the identity management computer 130. In implementations in which the directory of IP addresses and associated computer names is maintained at the policy database 104, source identification step 320 includes a step of querying the policy database 104 to determine the computer name.

The next decision step 322 determines whether the given account exists in the policy database, by querying the policy database 104. If it is determined at step 322 that there are no credentials or policies listed for the particular account, the request to establish the SSH session for the particular service is rejected at step 330. The authorization process 300 is exclusionary.

If the given account exists in the policy database 104, access rules containing the account credentials are obtained from the policy database 104 at step 322. As discussed above, the policy database may be centrally located at the identity management computer 130 or maintained at each server 90. The policy database 104 can be in the form of one or more databases, spreadsheets, directories, flat files, or other types of repositories or data stores. Accordingly, obtaining the credentials for the particular account can be accomplished, using structured query language (SQL) retrieval, lightweight directory access protocol (LDAP) query, or other suitable process for querying data stored in the policy database 104. If the policy database is not maintained at each server 90, but instead centrally maintained, certain of these attributes for the particular account are typically downloaded from the policy database 104 to the selected target server 90 and stored in the memory 128 for use within the remainder of the process 300.

In certain implementations, the account attributes can be limited to the specific parameters for which the request is based, e.g., the account, the particular client computer from which access is requested, the particular service requested, and the type of user authentication employed. With such a fine grained query, if these specific parameters are not satisfied in the consultation with the policy database 104, even though the account is present in the table as determined at step 310, the request to establish the SSH session for the particular service will be denied.

In some instances, particularly when the policy database is centrally located, it is desirable to broadly download attributes for a particular account as related to the target server and continue with the decision flow of process 300. The attributes contained in the access rules and downloaded for use in the process 300 can include the entire access rules table for the particular target server 90. Alternatively, the downloaded attributes can be specific to the account requesting access.

With a set of attributes for a particular account as related to the target server 90, the authorization process 300 proceeds to systematically compare the attributes derived from the policy database 104 to the account request. At step 324, it is determined whether the account has permission to access the target server from the particular source, i.e.; the client computer.

If the answer to step 324 is affirmative, the process 300 proceeds to determine whether the particular user authentication type employed to establish the identity of the user is permitted for the given user, source, and account at step 326. If the authentication type is permitted, the requested SSH session for that particular service is established 328. If the authentication type is permitted for the given user, source, and account, establishment of the SSH session for the requested service is rejected 330.

In other implementations, additional attributes can be compared to further control access not shown here. These attributes may include, but are not limited to, account or user group membership, target service type, number of access attempts, time of day, or day of week.

As can be appreciated, extending the capabilities of SSH by using private keys for authentication as well as for user authorization and tracking provides a significant advantage in that it reduces the need for impersonation and provides for more refined levels of access control and tracking Using public keys throughout the entire authentication and authorization process makes it easier to identify the actual user requesting access to a target server. Furthermore, combining the use of public keys for both authentication and authorization with a centralized database provides an important advantage in that the access rules are consistently applied regardless of when the changes are made. Since the access rules are maintained in only the central database, it is less complex to manage as changes only need to be made in one place and it is less complex to secure data in a single place. In addition, access attempts can be tracked more accurately since the identify of the actual user will be available as compared to impersonation, where the identify of the user is unknown. Moreover, since various implementations use existing SSH protocol, which is present in many operating systems, it allows client computers to access the resources of the servers regardless of the operating system running in the servers or the client computers so long as each can run the associated code for SSH protocol.

The foregoing specific implementations represent just some of the ways of practicing the present invention. Many other implementations are possible within the spirit of the invention. Accordingly, the scope of the invention is not limited to the foregoing specification, but instead is given by the appended claims along with their full range of equivalents.

What is claimed is:

1. A method comprising a plurality of steps each performed by hardware executing software, wherein the steps include:
receiving an access request for a target computer from a client computer, wherein the access request comprises a digital certificate belonging to a user;
verifying the identity of the user by validating the digital certificate;
receiving access privileges for the user from a policy database, wherein the access privileges contain one or more access attributes;
evaluating the access request based the one or more access attributes; and
granting the user access to the target computer if all of the one or more access attributes are satisfied.

2. A non-transitory computer readable medium comprising instructions which, when executed by a computing apparatus, performs the method of claim 1.

3. Any computer implemented method of establishing direct authentication with a server by a Secure Shell (SSH) connection with a user's public key without an impersonation, wherein a direct identification of the user is centrally validated and tracked by using the user's public keys when combined with a centralized policy database.

4. The method as defined in claim 3, wherein the establishment of the direct authentication further comprises the steps of:
retrieving policies from the centralized policy database
using a private key of the user to generate a digital certificate;
making a request, with the generated digital certificate, using SSH for a resource on a target server;
if the user's identity can be validated by using policies retrieved from the centralized policy, then authorizing the user to use the resource on the target server.

5. A non-transitory computer readable medium comprising instructions which, when executed by a computing apparatus, performs the method of claim 3.

6. A method comprising a plurality of steps each performed by hardware executing software, wherein the steps include:
receiving, from a client computer, an access request to an access management system, wherein the access request is for a target computer and includes a digital certificate belonging to a user;
upon verifying, with the access management system, the identity of the user by validating the digital certificate, granting the user privileges from a policy database, wherein the access privileges from the policy database contain one or more access attributes;
evaluating, by the access management, the access request using the one or more access attributes; and
upon a successful evaluation such that each of the access attributes is satisfied, granting, by the access management system, the user access to the target computer.

7. A non-transitory computer readable medium comprising instructions which, when executed by a computing apparatus, performs the method of claim 6.
